(19) United States
(12) Patent Application Publication
(10) Pub. No.: US 2006/0112079 A1
(43) Pub. Date: May 25, 2006

(54) System and method for generating personalized web pages

(75) Inventors: Alexander W. Holt, New Paltz, NY (US); Michael E. Moran, Ridgewood, NJ (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/995,672

(22) Filed: Nov. 23, 2004

(51) Int. Cl. G06F 17/30

(52) U.S. Cl. 707/3

(57) ABSTRACT

A web page personalization system and method. The system comprises: a web application server for serving a web page that includes personalized search results for a user requesting the web page; a content repository for storing content for the web page; a profiling system for dynamically providing profile attributes of the user when the web page is requested; and a search engine for generating the personalized search results using a query that is based a selected set of the provided profile attributes.

### BACKGROUND OF THE INVENTION

1. Technical Field

The present invention relates generally to generating web pages with personalized content, and more specifically relates to a system and method for generating personalized web pages using profile data to construct a personalized search.

2. Related Art

As more and more commerce and information is provided via a company's web portal, the ability to provide a gratifying user experience becomes more and more important. One such mechanism for enhancing the user experience involves providing dynamic content in the web pages served to the user. Dynamic websites display content that is dynamically determined at the time the web page is displayed. Thus, what is displayed on a given web page can change each time the user visits the page. Dynamic websites typically consist of an application server, a content repository, and a web server. They achieve very high performance through a combination of: (1) caching at the application server and content repository/database level based on the frequency of the requested pages and/or information, and (2) indexing in the database itself.

A further enhancement for improving the user experience involves providing personalized content. Personalized content is specifically tailored to the profile settings of the user, e.g., a portal page may display weather or stock quotes relating to the profile settings of the user. Unfortunately, the type of personalized content displayed by current systems is limited to a specified set of content, i.e., every visitor that asks for business news sees the same list of content, every visitor that wants to see the stock price of IBM sees the same value, etc. The reason for this is that when a website moves beyond just providing dynamic pages to personalized pages, the performance optimization described above loses efficiency. A personalized site generally includes an infrastructure that allows the user to register, login, and store/retrieve profile data. Typical profile data includes, e.g., name, address, interest data, etc. The loss in efficiency is driven by the extreme variable nature of this data. The data variability causes caching to be ineffective for generating page component details.

Current systems simulate true personalization by aggregating multiple queries on different subjects that are all presented as a unique combination on a page (e.g., My Yahoo, My Excite . . . ). These current systems rely on caching described earlier so that different sets of the same content can be shown to the user. However, as noted above, there is ultimately only a limited set of content that is made available to the end user.

As the desire for pages to become more and more personalized, existing systems will not be up to the task. Consider a site that wants to show a list of different articles on the subject of customer relationship management. Because the visitors to that page may work in different industries and have different job roles, the best articles to show will be different for each individual visitor. For example, a business executive might want to see CRM case studies for her industry, while an IT architect might want to see whitepapers of CRM solutions that fit into his company's technical architecture. For some situations, the criteria for selecting the documents might all be fielded metadata usually stored in a relational database, but much more precision can be obtained by utilizing unstructured content within the body of each document.

As profile information becomes more and more available on visitors to websites, there will be increasing business pressure for systems to provide lists of exactly the right documents to the visitor. For some situations, these documents can be sorted by date or other metadata fields (such as that provided by relational databases), but for much higher pertinence it is necessary to sort by relevance. Accordingly, a need exists for a personalized web page system that can provide highly personalized data to an end user.

### SUMMARY OF THE INVENTION

The present invention addresses the above-mentioned problems, as well as others, by providing a system and method for generating personalized web pages using profile data to construct a personalized search. In a first aspect, the invention provides a web page personalization system, comprising: a web application server for serving a web page that includes personalized search results for a user requesting the web page; a content repository for storing content for the web page; a profiling system for dynamically providing profile attributes of the user when the web page is requested; and a search engine for generating the personalized search results using a query that is based on a selected set of the provided profile attributes.

In a second aspect, the invention provides a personalized web page, comprising: a display area having dynamic content that includes a set of personalized search results; and a query constructor process for generating a query that can be used to provide the personalized search results, wherein the query constructor process includes: a process for retrieving a predetermined set of profile attributes of the user viewing the web page; and a process for generating a query based on the retrieved profile attributes of the user and a predetermined set of relevant web page attributes.

In a third aspect, the invention provides a method of generating personalized web pages from a website, comprising: storing web page content in a content repository; storing profile data for users of the website; receiving a request for a web page; dynamically providing profile attributes of a user requesting the web page; forming a query based on the provided profile attributes of the user; submitting the query to a search engine to generate personalized search results; and serving the web page to the user with the personalized search results.

In a fourth aspect, the invention provides a web application server for serving personalized web pages on a website, comprising: means for accessing web page content in a content repository; means for accessing profile data for users of the website; means for receiving a request for a web page; means for dynamically determining profile attributes of a user requesting the web page; means for forming a query based on the provided profile attributes of the user; means for submitting the query to a search engine to generate personalized search results; and means for serving the web page to the user with the personalized search results.

In fifth aspect, the invention provides a method for deploying an application for generating personalized web content, comprising: providing a computer infrastructure being operable to: access web page content in a content repository; access profile data for users of the website; receive a request for a web page; dynamically determine profile attributes of a user requesting the web page; form a query based on the provided profile attributes of the user; submit the query to a search engine to generate personalized search results; and serve the web page to the user with the personalized search results.

In a sixth aspect, the invention provides computer software embodied in a propagated signal for generating personalized web pages, the computer software comprising instructions to cause a computer to perform the following functions: receive a request for a web page; dynamically determine profile attributes of a user requesting the web page; form a query based on the provided profile attributes of the user; submit the query to a search engine to generate personalized search results; and serve the web page to the user with the personalized search results.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a web page personalization system in accordance with the present invention.

FIG. 2 depicts a personalized web page in accordance with the present invention.

FIG. 3 depicts a first set of personalized search results in accordance with the present invention.

FIG. 4 depicts a second set of personalized search results in accordance with the present invention.

### DETAILED DESCRIPTION OF THE INVENTION

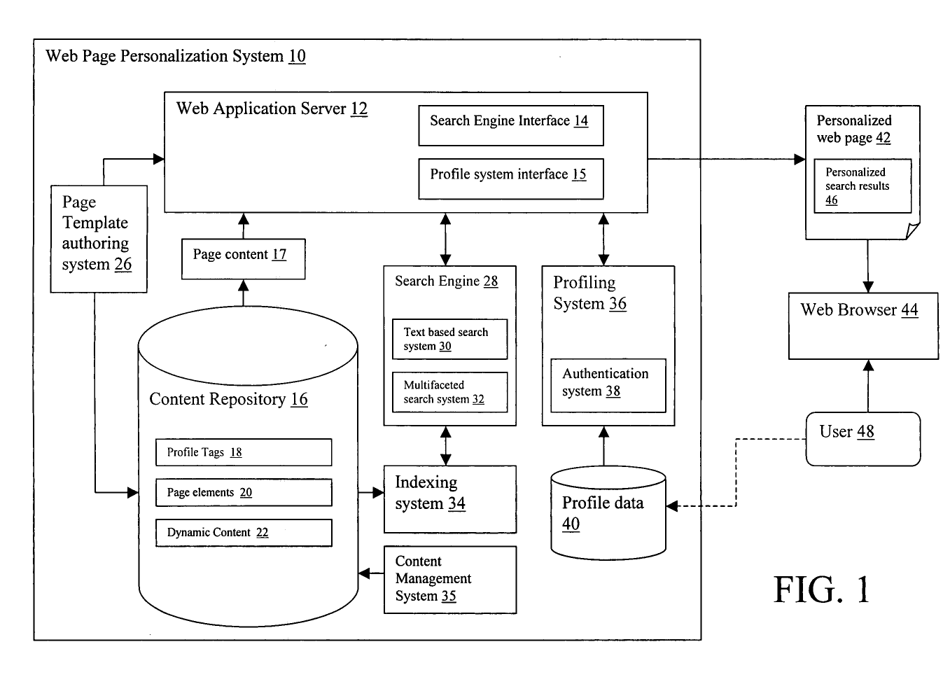

Referring now to the drawings, FIG. 1 depicts a web page personalization system 10 which, upon a request from a user 48 operating web browser 44, generates a personalized web page 42. Personalized web page 42 includes a set of personalized search results 46 provided by a search engine 28 in response to a dynamically generated query. As described in further detail below, a personalized query is generated based on profile attributes of user 48, as well as attributes of the web page 42 being requested. Thus, personalized web page 42 contains search results unique to the user requesting the web page 42.

Included in web page personalization system 10 is: (1) a web application server 12 that provides, e.g., a web portlet, which receives web page requests and serves personalized web pages 42; (2) a content repository 16 for storing page content 17; (3) a search engine 28; (4) and a profiling system 36 that includes profile data of users that are registered with, or recognized by, the web application server 12. Also included is indexing system 34 that indexes the content in the content repository 16 for the search engine 28. Thus, in the case of a web portlet, users may have the option to search for content in the content repository 16, or elsewhere on the Web. Finally, a page template authoring system 26 is provided for creating web page templates for the portlet and which, as described below, dictates the relevant profile and page attributes to be used in constructing queries when web pages are served from the portlet.

Web application server 12 includes a system (or programmatic interface) for providing dynamic content, such as JAVA™, PERL™, PYTHON™, etc. In this embodiment, dynamic content 22 and other page elements 20 are stored in content repository 16. Systems for serving dynamic content 22 are known in art, e.g., WEBSPHERE™, BEA WEBLOGIC™, etc. In this case, the dynamic content 22 includes a set of personalized search results 46. When a user 48 first visits the web application server 12, the profile attributes of the user 48 are retrieved by the profiling system 36 via the profile system interface 15. An authentication system 38 (e.g., user name and password) may be implemented as part of the process. Profile data 40 may include any relevant information about the user, e.g., name, address, company location, company size, job type, interests, skills, hobbies, etc. Note that while the web application server 12 is generally described as providing a web portlet, it should be understood that the scope of the present invention is not limited to portlets, i.e., the systems and processes for providing personalized content described herein could be utilized in any client-server environment.

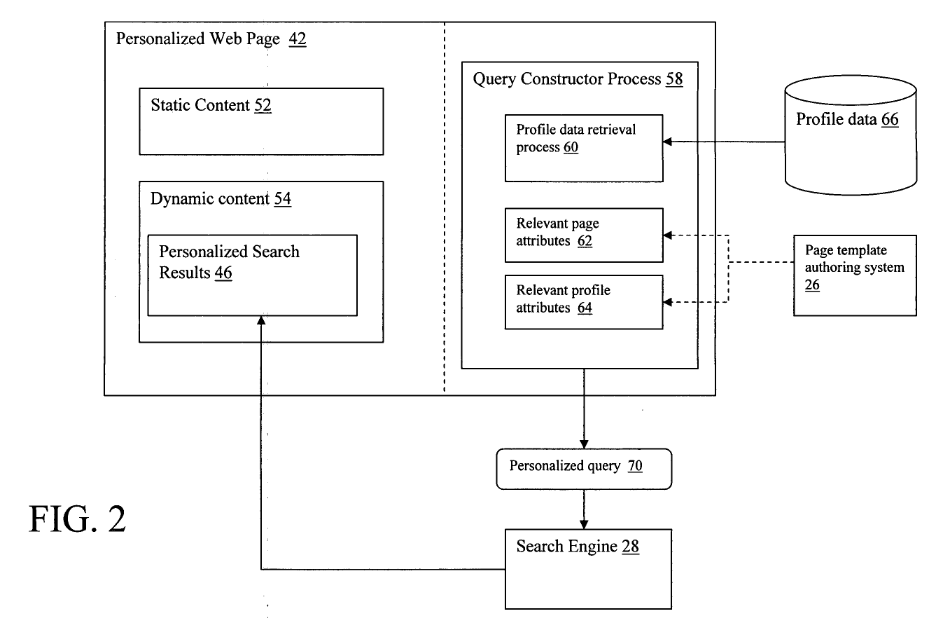

When a personalized web page 42 is requested, a search engine interface 14 is utilized to pass a query to the search engine 28 based on the profile attributes of the user, as well as attributes of the web page. The rules for constructing the query may be implemented by the web page 42, the web application server 12, a third party process, etc. Further details regarding constructing queries are provided below with regard to FIG. 2. Based on the query, search engine 28 returns the personalized search results 46, which are used to populate the personalized web page 42 displayed to the user 48.

In the event that no profile exists for the user, the web application server 12 can issue a query based on a generic or default rule, e.g., based on other pages visited by the user, based on the subject matter of the page, etc. Thus, the invention can be used by portlets that allow anonymous users.

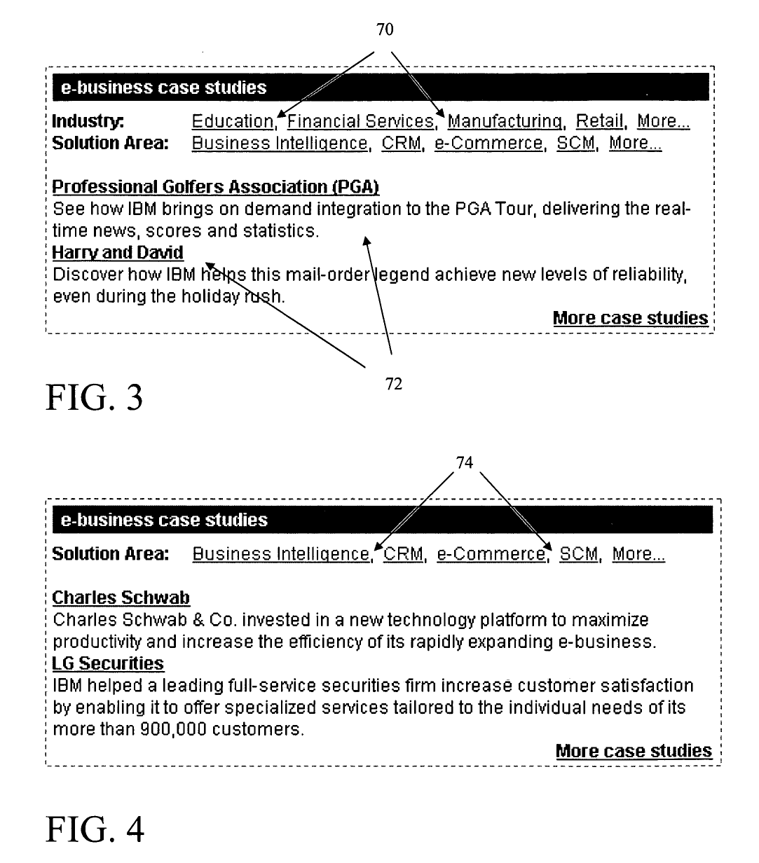

Search engine 28 includes both a text based search system 30, and a multifaceted search system 32. An example of a multifaceted search system 32 is shown in FIGS. 3 and 4. A multifaceted search allows the user to “drill down” in the results by selecting a category 70. For instance, as shown in FIG. 3, in addition to obtaining a list of search results 72, various categories 70 (e.g., Education, Financial Services, Manufacturing, etc.) are provided. In this case, the user can select one of the categories to further refine the search results 72. For instance, if the user selected Financial Services, a new set of search results shown in FIG. 4 would be presented. As can be seen, the user is again presented with categories 74 to further refine the search. Thus, the designer of the web page can determine the granularity of initial search, e.g., to ensure that an adequate number of results will always be returned. In addition, by utilizing a text based search system 30, the resulting content list can be ranked appropriately to show the most relevant content to the user.

In the case of a web portal, content repository 16 may be the primary content resource for the search engine 28. To facilitate the search process, content repository 16 may utilize profile tags 18 to tag content as being relevant to predefined profile attributes. For example, content relating to a CRM solution for a small retail operation may be tagged with a “small business” attribute so that it will be located during a search for a user working for a small company. The content repository 16 may be implemented in any fashion, e.g., as a relational database, as a flat file system, etc.

Indexing system 34 may utilize a content processor to analyze each page in the content repository 16 against a standard taxonomy to determine the metadata that must be indexed, e.g., subject, document type, date, etc. Each field in the document can be indexed for multifaceted retrieval. Alternatively, a content management system 35 could be implemented in which each type of document uses a DTD that defines the standard values for each tagged field. The content management system 35 would then push each document into the search index when the document is published. Moreover, content management system 35 could be implemented to feed multiple content repositories that are shared by a single portal. Accordingly, it should be understood that any system for indexing data and/or unifying disparate content management systems and runtime repositories could be utilized.

As noted, profiling system 36 stores the user's profile attributes (i.e., profile data 40). Profiling system also provides an authentication system 38 that provides the profile system interface 15 to the web application server 12 for authenticating users. The web application server 12 may invoke the profile system interface 15 to the user 48 when a web page is first displayed, and then use some mechanism, e.g., cookies, to ensure that subsequent visits are personalized.

Referring now to FIG. 2, a personalized web page 42 is shown that includes both static content 52 and dynamic content 54. Dynamic content 54 includes personalized search results 46 generated, e.g., using the system described in FIG. 1. As noted above, any time the personalized web page 42 is viewed, a personalized query 70 is constructed, which allows search engine 28 to provide personalized search results 46. In this illustrative embodiment, personalized query 70 is created with a query constructor process 58 embedded in the personalized web page 42. It should be noted that query constructor process 58 could likewise be implemented, in part or whole, by the web application server 12, or by a third party process.

To create the personalized query 70, query constructor process 58 includes a profile data retrieval process 60 that causes the retrieval of profile data 66 of the user viewing the page. Embedded in the page 42 are a set of relevant page attributes 62 and a set of relevant profile attributes 64. Each is predetermined by an author of the page when the page is first authored using, e.g., a page template authoring system 26. The attributes 62, 64 determine the search parameters that will make up personalized query 70.

The relevant page attributes 62 will typically include one or more search terms about the page being viewed. For example, if the page being viewed is a page about laptops for businesses, a relevant page attribute might be “laptop.” Furthermore, a relevant profile attribute 64 might be “company type.” If the retrieved profile data 66 of the user included a profile attribute for “business size” (e.g., small, medium, large, etc.), then that retrieved profile attribute could likewise be used in the personalized query 70. Thus, in this example, personalized query 70 could be constructed as: “LAPTOP & SMALL BUSINESS,” which would cause the search engine 28 to return laptop content relevant to small businesses. Obviously, the number and type of attributes 62, 64 utilized depends on the particular application.

It should be appreciated that web page personalization system 10 of the present invention could be carried out on a stand-alone computer system, or over a network such as the Internet, a local area network (LAN), a wide area network (WAN), a virtual private network (VPN), etc. Suitable computer systems may include a mainframe, a desktop computer, a laptop computer, a workstation, a hand held device, a client, a server, etc. In any event, the computer system may generally comprise, e.g., a processing unit, memory, a bus, input/output (I/O) interfaces, external devices/resources and a storage unit. The processing unit may comprise a single processing unit, or processors distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, similar to processing unit, memory may reside at a single physical location, comprising one or more types of data storage, or be distributed across a plurality of physical systems in various forms.

I/O interfaces may comprise any system for exchanging information to/from an external source. External devices/resources may comprise any known type of external device, including a scanner, a storage device, a network connection, speakers, a hand-held device, a keyboard, a mouse, a voice recognition system, a speech output system, a printer, a monitor/display, a facsimile, a pager, etc.

Databases including content repository 16 and profile data 40 may each comprise any type of storage unit capable of providing storage for information under the present invention. As such, the storage units could include one or more storage devices, such as a magnetic disk drive or an optical disk drive. Moreover, the storage units may include data distributed across, for example, a local area network (LAN), wide area network (WAN) or a storage area network (SAN).

Thus, it should also be understood that while the invention is described as a single integrated architecture, the invention could be implemented in a distributed fashion where the components and subsystems do not necessarily reside at the same physical location.

It should also be understood that the present invention can be realized in hardware, software, a propagated signal, or any combination thereof. Any kind of computer/server system(s)—or other apparatus adapted for carrying out the methods described herein - is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

It should also be appreciated that the teachings of the present invention can be offered as a business method on a subscription or fee basis. For example, a computer system could be created, maintained, supported, and/or deployed by a service provider that offers the functions described herein for customers.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A web page personalization system, comprising:
a web application server for serving a web page that includes personalized search results for a user requesting the web page;
a content repository for storing content for the web page;
a profiling system for dynamically providing profile attributes of the user when the web page is requested; and
a search engine for generating the personalized search results using a query that is based on a selected set of the provided profile attributes.

2. The web page personalization system of claim 1, further comprising an indexing system for indexing content stored in the content repository.

3. The web page personalization system of claim 1, wherein the search engine includes both a text base search system and a multifaceted search system.

4. The web page personalization system of claim 1, wherein the query is further based on a selected set of web page attributes.

5. The web page personalization system of claim 4, wherein the selected set of the provided profile attributes and the selected set of web page attributes are predetermined by a page template authoring system.

6. The web page personalization system of claim 1, wherein the profiling system includes an authorization system.

7. A personalized web page, comprising:
a display area having dynamic content that includes a set of personalized search results; and
a query constructor process for generating a query that can be used to provide the personalized search results, wherein the query constructor process includes:
a process for retrieving a predetermined set of profile attributes of the user viewing the web page; and
a process for generating a query based on the retrieved profile attributes of the user and a predetermined set of relevant web page attributes.

8. The personalized web page of claim 7, further comprising a second display area having static content.

9. A method of generating personalized web pages from a website, comprising:
storing web page content in a content repository;
storing profile data for users of the website;
receiving a request for a web page;
dynamically providing profile attributes of a user requesting the web page;
forming a query based on the provided profile attributes of the user;
submitting the query to a search engine to generate personalized search results; and
serving the web page to the user with the personalized search results.

10. The method of claim 9, further comprising the step of indexing content stored in the content repository.

11. The method of claim 9, wherein the generated search results include both a text base search results and multifaceted search results.

12. The method of claim 9, wherein the query is further based on a selected set of web page attributes.

13. The method of claim 12, comprising the further step of predetermining the provided profile attributes and the selected set of web page attributes by a page template authoring system.

14. The method of claim 12, comprising the further step of authorizing the user.

15. A web application server for serving personalized web pages on a website, comprising:
means for accessing web page content in a content repository;
means for accessing profile data for users of the website;
means for receiving a request for a web page;
means for dynamically determining profile attributes of a user requesting the web page;
means for forming a query based on the provided profile attributes of the user;
means for submitting the query to a search engine to generate personalized search results; and
means for serving the web page to the user with the personalized search results.

16. The web application server of claim 15, further comprising means for authorizing the user.

17. A method for deploying an application for generating personalized web content, comprising:
providing a computer infrastructure being operable to:
access web page content in a content repository;
access profile data for users of the website;
receive a request for a web page;
dynamically determine profile attributes of a user requesting the web page;
form a query based on the provided profile attributes of the user;
submit the query to a search engine to generate personalized search results; and
serve the web page to the user with the personalized search results.

18. Computer software embodied in a propagated signal for generating personalized web pages, the computer software comprising instructions to cause a computer to perform the following functions:
receive a request for a web page;
dynamically determine profile attributes of a user requesting the web page;
form a query based on the provided profile attributes of the user;
submit the query to a search engine to generate personalized search results; and
serve the web page to the user with the personalized search results.

19. A program product stored on a computer readable medium, which when executed generates personalized web page, the program product comprising:
program code configured to receive a request for a web page;
program code configured to dynamically determine profile attributes of a user requesting the web page;
program code configured to form a query based on the provided profile attributes of the user;
program code configured to submit the query to a search engine to generate personalized search results; and
program code configured to serve the web page to the user with the personalized search results.
